(19) United States
(12) Patent Application Publication
(10) Pub. No.: US 2003/0174135 A1
(43) Pub. Date: Sep. 18, 2003

(54) System and method for utilizing multiple fonts

(76) Inventors: Joel Gyllenskog, Boise, ID (US); Daniel L. Posey, Boise, ID (US)

Correspondence Address: ROBERT A. HUNTSMAN, 4466 S. RIVA RIDGE WAY, BOISE, ID, 83709, US

(21) Appl. No.: 10/097,881

(22) Filed: Mar. 13, 2002

(51) Int. Cl. G06T 11/00

(52) U.S. Cl. 345/471

(57) ABSTRACT

This invention teaches a system and method for printing bar codes and forms in a soft font environment. Special codes that identify the underlying font and character code of a screen font are encoding in the drawing instructions of a soft font, allowing systems that monitor print data to identify the original character strings and substitute alternate printing fonts, even in environments where coding information is discarded during print text formatting. Applications, such as barcode applications that require additional characters to produce a barcode suitable for scanning, can seamlessly provide the additional control characters without interaction from the user or application program.

### BACKGROUND

Modern computing systems are often deployed to print barcodes that are prevalent in modern society. For example, most retail stores encode retail products with a barcode that is scanned at the check-out counter. The barcode is typically an encoded product number that is used by a computer to look up the product name, description, and the price, providing several useful benefits such as freeing the check-out clerk from typing in the price and providing the customer with an enhanced receipt that typically includes the product name and description as well as the price.

In many computer applications it is desirable to have the characters on the screen accurately reflect what the characters will look like when printed. However, in certain computer printing applications it is desirable to have the characters on a screen differ from those being printed. The present invention deals with the latter group of computer applications that require the screen representation to differ from the printed representation of the same characters. In a barcode application, for example, one would prefer that characters on the screen be in a human readable form, yet be printed as actual barcodes. In barcode applications, the printed characters differ from the ideal screen characters in at least two important ways. First, the actual printed images, called glyphs, must differ between the screen and the printer, because a human viewer would like to see the letter “A” on the screen, but desires the actual barcode consisting of a series bars on the printer. Second, printed barcodes typically require extra characters called start codes, stop codes and checksum digits in addition to the characters being encoded. Thus in these special situations, more characters are needed for printing than for screen viewing.

Fonts are descriptions of characters to be printed or drawn. In modern printers, fonts are generally either hard fonts or soft fonts. Hard fonts are built into the printer or added to the printer with a cartridge or electronic module. Soft fonts are fonts that are defined and described in a computer file and downloaded to a printer or computer on demand.

Primitive barcode applications simply use one font and character set for the screen and another for the printer, and map characters one-for-one. This requires the application to explicitly add the start, stop and checksum characters, a time consuming and error-prone task. Furthermore, this scheme does not work well with soft fonts. With a soft font, the font and its associated characters are described using a font definition that contains well-defined character drawing instructions for each character in the font. The drawing instruction may be algebraically descriptive, where the lines making the character are described. Alternatively, the drawing instructions may be a bitmap, where characters are described by identifying each geometric point in a character. Both types of instructions are well defined in the art. Both printers and computers typically are able to process the font drawing instructions and thus can draw characters on demand using the same font definition. Soft font implementations work well in applications where the screen rendition reflects the printed rendition of characters. However, the soft font model does not work well with certain applications requiring the printed renditions to differ from the viewed rendition such as barcodes and forms drawing packages because in these applications a single set of drawing instructions is not sufficient to render both screen and printed characters.

In applications like barcode applications where the printed font differs from the screen representations, it is desirable to have the necessary conversion from screen characters to printer characters performed automatically, to relieve the application program and the user of an application program from the details of the conversion. For example, in the case of barcodes, there are number of technologies to assist an application program in translating human readable characters into barcodes suitable for reading. The use of such applications will produce acceptable barcodes, but are cumbersome to use. These application determine the additional control characters required by the various barcode symbologies. Co-pending patent application Ser. No. 09/953,421 describes this technology in detail and is hereby included by reference.

One difficulty of altering the printer font from the screen font in a soft font environment is that certain soft font technologies, notably Microsoft Windows TrueType fonts and Adobe Type 1 fonts, strip the font and character identity from the print stream and send only the drawing instructions to the printer. Thus it is difficult to properly and seamlessly modify such print streams to use a different font and character stream for printing than that use for screen viewing because needed information is missing. What is needed is a way for software modules that monitor and modify the print data stream to accurately identify fonts and characters within monitored print data being sent to a printer.

### SUMMARY OF THE INVENTION

The present invention addresses the limitations cited above by teaching a system and method for providing separate screen fonts and printer fonts in a soft font environment in such a way that applications like barcode applications can seamlessly translate screen characters into appropriate printed characters. In the preferred embodiment, font and character identification information is encoded in the character drawing instructions by creating custom soft fonts with special character encodings within the drawing instructions. The included encodings may cause a slight deviation in the appearance of the character when rendered on the screen because the instructions for drawing a particular curve or a bit pattern for a select section of the character are altered to include the font and character identity codes. However, the altered appearance is generally very slight and is only apparent to very astute viewers. Such altered drawing instructions will only be rendered on the screen when deploying the invention. A different font is generally used for printing. Thus each custom soft font renders characters for screen viewing using a character drawing language, including bitmap specifications, suitable for human viewing, but further includes easily parsable text or bit patterns within the character drawing instructions that identify the font and character to be drawn. When an application indicates that characters in this custom font are to be printed, the system, typically in a print driver or print daemon, will construct a data set containing the character drawing instructions. Since the character drawing instructions now contain font and character identification codes, modules that process the character processing instructions can accurately identify the fonts and characters as presented on the screen and make intelligent modifications to the print data. This teaching allows applications, like barcode applications and forms applications, to run seamlessly, without human intervention, and automatically convert a human friendly screen viewing character set and font to a special purpose printing font for printing barcodes or custom forms.

### DESCRIPTION OF THE DRAWINGS

FIG. 1 is a drawing of print data flow using soft fonts according to the prior art.

FIG. 2 is a drawing of print data flow using hard barcode fonts contained within a printer according to the prior art.

FIG. 3 is a drawing of print data flow using soft fonts according to preferred embodiment of the present invention.

### DETAILED DESCRIPTION OF THE PREFERRED EMBODIMENT

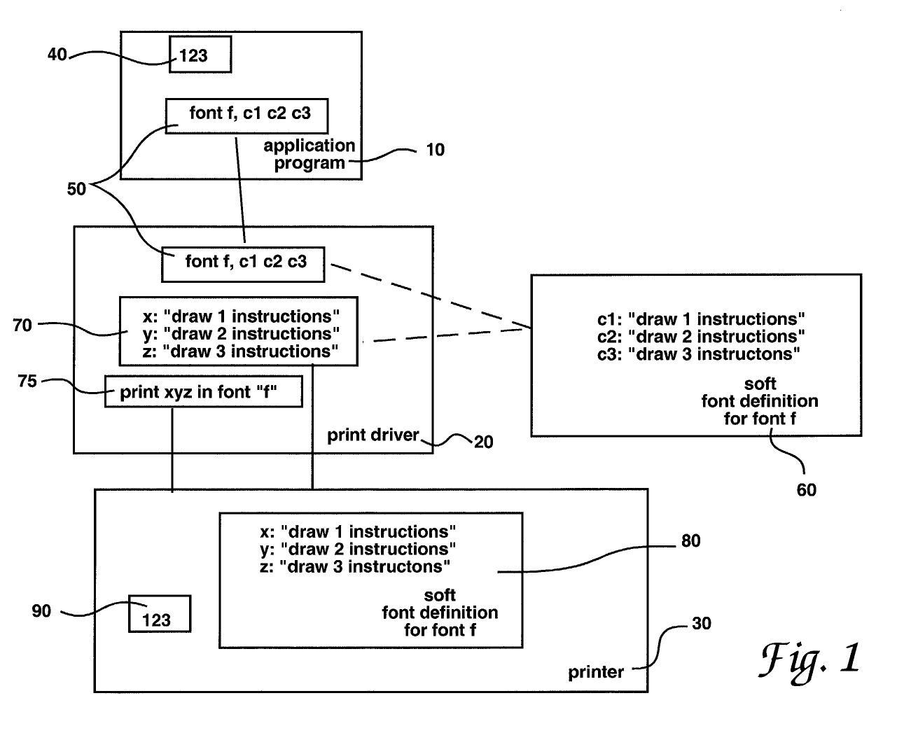

In order to understand the present invention, it is helpful to understand how prior art systems deal with soft fonts. FIG. 1 illustrates generally how a soft font is used to draw characters to both a screen and printer using the same drawing instructions. Referring to FIG. 1, a typical prior art system includes an application program 10 that resides on a computer (not shown), the computer typical includes a printer driver 20 that formats text from the application program 10 for a particular printer 30. By way of hypothetical illustration, suppose the program logic of the application program dictates that the text “123” of a particular font f is to be depicted on the screen 40. In order to determine how the characters are to be drawn, the application program 10 relies on the definition of font f which includes drawing instructions for each character in that font, including “1”, “2”, and “3”. In order to cause the characters to be printed, the application formats the data into a dataset 50 that indicates font f is selected, and characters internally identified as c1, c2, and c3 of that font are to be printed. The dataset 50 is transmitted to the printer driver 20. The print driver 20 has previously loaded a soft font definition 60 for font f which contains explicit drawing instructions for some or all characters of font f, including “1”, “2”, and “3”. The print driver 20 makes a new data set 70 that contains a new arbitrary code for each character to be printed and the drawing instructions for the character. In FIG. 1, the arbitrary new codes are “xyz”. The new dataset 70 is transmitted to the printer 30, thus enabling the printer to print what it knows as characters x, y, and z. The print driver will then send down print instruction 75 to print characters xyz in font f. The printer 30 reviews its table 80 of characters previously downloaded and notes that it has drawing instructions for characters x, y, and z. It retrieves the appropriate drawing instructions from table 80 for each character and prints then on printable media 90, which results in “123” being printed on the printer. In the system of FIG. 1, the characters on the printer reflect the characters on the screen.

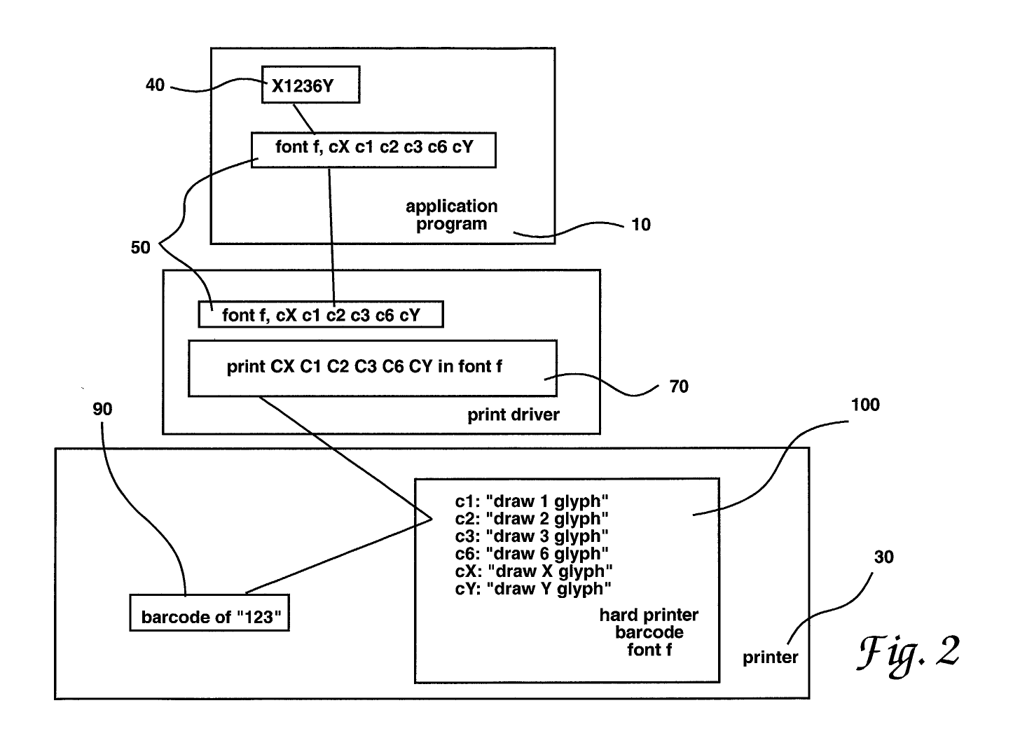

FIG. 2 shows a simpler prior art case using a hard font that is loaded into the printer. In FIG. 2, the printer 30 contains a hard barcode font f 100. Unlike FIG. 1, the character rendered on the screen 40 and the characters rendered on the printer 90 are different. In this case, an actual barcode 90 is printed. To achieve this result, the application program or the user of the application has to input the extra start, stop and checksum characters needed for barcode printing. The is represented by the X1236Y in the application, where X is a start code, Y is a stop code, 6 is a checksum character, and “123” is the data to be encoded as a barcode. Thus “X1236Y” is explicitly rendered in the application program 10. A data packet 50 identifying the font f and the character code for each of the six characters are transmitted to the print driver. In this case no additional translation is needed and the packet is presented to the printer 30, which looks up the appropriate glyphs for the barcodes from the printer font definition for barcode font “f” 100 and renders a barcode 90 of “123” on the printer 30. Thus, in the FIG. 2 example, barcodes are printed, but the user or application must exercise explicit knowledge of barcode encoding rules.

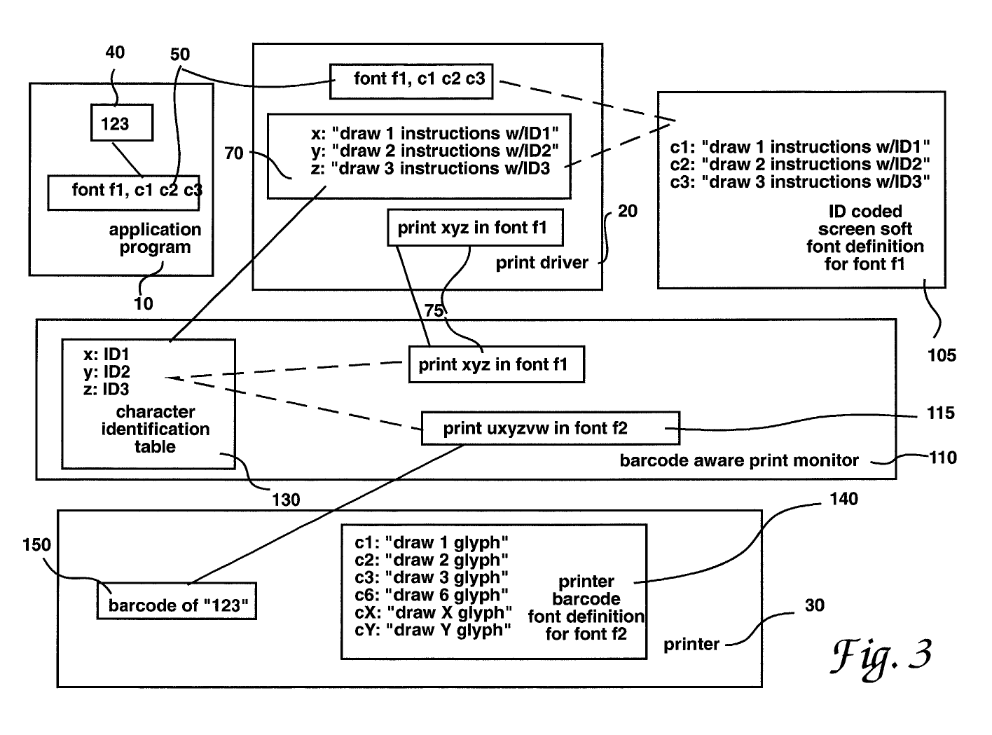

FIG. 3 is illustrates the preferred embodiment of the present invention. The teaching of FIG. 3 differs from FIG. 1 in that the FIG. 3 system can render printer characters different from screen characters. The teaching of FIG. 3 differs from that of FIG. 2, in that the preferred embodiment of FIG. 3 prints barcodes without requiring the user or the application program to provide start, stop or checksum characters, thus providing transparent barcode printing.

Referring to FIG. 3, FIG. 3 teaches a system that uses two fonts f1 and f2. Font f1 is an ID coded screen soft font definition 105; it defines the font used for screen representation. Font f2 is printer barcode font 140 and identifies the font that will be printed, which in the preferred embodiment is a font that prints barcode glyphs. Font f2 140 may be a hard or soft font. Since the screen font 105 and the printer font 140 are distinct, the screen font can be designed in a number of useful ways, including special Latin letters with black marks above them to remind the viewer that using this font on the screen will result in printed barcodes.

When the logic of the application program determines characters 40 on a screen are to be printed, the application prepares a dataset 50 that identifies the font and character codes and transmits them to the print driver 20. The print driver 20 retrieves the drawing instructions for each character from the font definition 105, and builds a table 70 in the print driver 20, containing an arbitrary code and drawing instructions for each character. In this illustration, the arbitrary character codes for 1, 2, and 3 are x, y, and z. In the preferred embodiment, a barcode aware print monitor 110 is interfaced between the print driver 20 and the printer 30, and thus receives the font character download and the print data destined for the printer 30. When the barcode aware print monitor 110 receives character download information, it inspects the drawing instructions for each character and determines whether or not each character is from the special ID coded screen soft font definition 105. If so, it builds its own character identification table 130 that stores, among other things, the actual font and character code of each character. However, instead of passing the drawing instructions to the printer 30, the print monitor 110 substitutes printer-specific codes from printer barcode font definition f2 140. Furthermore, if font f2 140 is not native to the printer 30, the printer monitor 110 can maintain a suitable font and download it to the printer 30 transparent to the application program or user. When the print monitor 110 receives a dataset with data to be printed 75, it inspects data and identifies the font of the data. If the identified font is one in its table 130, then character substitution is required. The print monitor 110 may translate the characters from screen font f1 to printer font f2 and add any start, stop and checksum characters required by the barcode symbology of the printer font 140. The print monitor 110 has the necessary information to perform this operation because the character identification table 130 has the actual font and character codes (1,2,3 in this example). This is important because the arbitrary codes x, y, and z, cannot be used to determine the checksum required and furthermore are not characters in the printer font 140. The modified dataset 115 is passed to the printer 30, which renders the appropriate barcode 150.

This illustration is provided by way of illustration, not implementation. The practice of encoding font and character information taught here can be deployed in a variety of ways and in a variety of different computing environments using a variety of font technologies. The invention is limited only by the claims set forth below.

We claim:

1. A system for defining a font comprising:
a font name,
a plurality of character definitions, each character definition further comprising character drawing instructions, and character identification information,
wherein the character identification information is encoded within the character drawing instructions.

2. The system of claim 1 wherein the character identification information further includes a font identifier and a character code.

3. A method for defining a font, the method comprising the steps of:
choosing a font name,
defining a plurality of characters, each character is defined by:
specifying character drawing instructions capable of rendering the character, and
encoding character identification information within the character drawing instructions.

4. The method of claim 3 wherein the character identification information further includes a font identifier and a character code.

5. A method for rendering characters on a viewing device and a printing device, the method comprising the steps of:
defining a font by:
choosing a font name,
defining a plurality of characters, each character is defined by:
specifying character drawing instructions capable of rendering the character, and
encoding character identification information within the character drawing instructions,
choosing a first character string,
choosing a printer font having a plurality of characters,
rendering the first character string on the viewing device,
creating a second character string wherein each character in the second character string is formed by replacing the character with a character from the printer font associated with the character identification information.

6. The method of claim 5 wherein the character identification information further includes a font identifier and a character code.

7. The method of claim 5 wherein the method further comprises the step of creating a third character string wherein the third character string includes the characters of the second character string and further includes control characters associated with the second character string.

8. The method of claim 7 wherein the character identification information further includes a font identifier and a character code.

9. The method of claim 7 wherein the method further comprises the step of rendering the third character string on the printing device.

10. The method of claim 7 wherein the printer font is a barcode font and the third character string renders scannable barcodes.

11. The method of claim 7 wherein the character identification information further includes a font identifier and a character code.

12. The method of claim 9 wherein the printer font is a barcode font and the third character string renders scannable barcodes.

13. The method of claim 7 wherein the character identification information further includes a font identifier and a character code.

14. The method of claim 7 wherein the printer font is a form drawing font and the third character string renders a form.

15. The method of claim 7 wherein the character identification information further includes a font identifier and a character code.

16. The method of claim 9 wherein the printer font is a form drawing font and the third character string renders a form.

17. The method of claim 7 wherein the character identification information further includes a font identifier and a character code.
